(19) United States
(12) Patent Application Publication
(10) Pub. No.: US 2016/0175808 A1
(43) Pub. Date: Jun. 23, 2016

(54) CARBON DIOXIDE ADSORBENT WITH AMINO ACID-BASED AMINE GROUP GRAFTED THERETO AND METHOD OF MANUFACTURING SAME

(71) Applicant: MYONGJI UNIVERSITY INDUSTRY AND ACADEMIA COOPERATION FOUNDATION, Gyeonggi-do (KR)

(72) Inventors: Jeong Gil SEO, Gyeonggi-do (KR); Kyu Young LEE, Gangwon-do (KR); Hanyeong LEE, Gyeonggi-do (KR); Vishwanath HIREMATH, Gyeonggi-do (KR)

(73) Assignee: MYONGJI UNIVERSITY INDUSTRY AND ACADEMIA COOPERATION FOUNDATION, Gyeonggi-do (KR)

(21) Appl. No.: 14/723,853

(22) Filed: May 28, 2015

(30) Foreign Application Priority Data
Dec. 18, 2014 (KR) 10-2014-0183400

(51) Int. Cl. B01J 20/22; B01J 20/10; B01J 20/30; B01D 53/02

(52) U.S. Cl. CPC B01J 20/22; B01D 53/02; B01J 20/103; B01J 20/3071; B01J 20/3085; B01D 2257/504

(57) ABSTRACT

Disclosed herein are a carbon dioxide adsorbent with an amino acid-based amine group grafted thereto, and a method for manufacturing the same by grafting an ionic liquid-loaded porous support, having large surface area, with an amine group through ion exchange and neutralization with an amino acid. Having excellent carbon dioxide adsorption performance, selectivity for carbon dioxide, thermal stability, and reusability, the carbon dioxide adsorbent of the present invention can be effectively applied to the prevention of environmental pollution produced by carbon dioxide release.

### SPECIFIC REFERENCE TO A GRACE PERIOD INVENTOR DISCLOSURE

This invention has been published in Conference “Tokyo Conference on Advanced Catalytic Science and Technology (TOCAT7)” on Jun. 1, 2014, by the inventor or joint inventors.

### BACKGROUND OF THE INVENTION

1. Field of the Invention

The present invention relates to a carbon dioxide adsorbent. More particularly, the present invention relates to a carbon dioxide adsorbent with an amino acid-based amine group grafted thereto, which is of high thermal stability and exhibits carbon dioxide adsorption performance. Also, the present invention is concerned with a method for manufacturing the carbon dioxide adsorbent by grafting an ionic liquid-loaded porous support, having a large surface area, with an amine group through ion exchange and neutralization with an amino acid.

2. Description of the Related Art

An increase in global energy consumption has led to the increase in global emissions of carbon dioxide, resulting in one of the most controversial environmental issues ever. To regulate the annually increasing concentration of atmospheric carbon dioxide, various plans have been sought for utilizing carbon dioxide capture/storage technologies. In the field of carbon dioxide capture, many attempts have been made to concentrate/separate carbon dioxide by use of dry/wet/membrane methods. Of them, the wet amine method exhibits the best performance. In this context, studies have been focused on alkanol amines such as monoethanol amine and N-methyldiethanol amine (MEA).

However, carbon dioxide capture by amines is an expensive energy intensive process which has difficulty in separating carbon dioxide on a mass scale, and which always presents the problems of facility corrosion and toxicity. To remedy the wet amine method's problems of low reusability and causticity, solid absorbents were suggested. Thus, research has been directed toward physical adsorption of porous adsorbents such as zeolites, silica gel, alumina, active carbon, etc. These porous adsorbents, however, suffer from the problem of having low selectivity for carbon dioxide and low water resistance.

An ionic liquid has arisen as an alternative for carbon dioxide capture thanks to its non-volatility, non-flammability, high thermal stability, and applicability to various uses. It was found that carbon dioxide can be dissolved in an imidazolium-based ionic liquid at a high pressure. It was also reported that the amine group allows an ionic liquid to increase in carbon dioxide solubility when it is introduced into a cation of the ionic liquid. Since then, ionic liquids with amine groups in various forms grafted thereto have been studied. An amino acid is regarded as a molecule bearing an amine group.

Leading to the present invention, intensive and thorough research into carbon dioxide capture and storage resulted in the finding that when a porous support having a large surface area is grafted with an amino acid-based amine group through ion exchange and neutralization with an amino acid, the resulting carbon dioxide adsorbent is of excellent thermal stability and exhibits excellent adsorption performance without suffering from conventional amine-based carbon dioxide adsorption method's problems of toxicity, causticity, and low reusability.

With regard to related techniques, reference may be made to Korean Patent Nos. 10-1071774 (Amidium-based ionic liquids for carbon dioxide absorption), and 10-1122714 (Carbon dioxide absorbents using the imidazolium-based ionic liquid compound comprising fluorinated olefin).

### SUMMARY OF THE INVENTION

It is therefore an object of the present invention to provide a carbon dioxide adsorbent that is of excellent thermal stability and adsorption performance while being free of conventional amine-based carbon dioxide adsorption method's problems of toxicity, causticity, and low reusability; and a method for manufacturing the same, characterized by the introduction of an amino acid-based amine functional group into an ionic liquid-loaded porous support.

In order to accomplish the above object, an aspect of the present invention provides a carbon dioxide adsorbent comprising an ionic liquid-loaded porous support with an amino acid-based amine functional group introduced thereinto.

In one embodiment of the present invention, the ionic liquid may be is prepared by: (1) heating 1-methylimidazole in mixture with (3-chloropropyl)trimethoxysilane while stirring in a nitrogen atmosphere; (2) cooling the reaction mixture of step (1) to room temperature, followed by washing with diethyl ether; (3) concentrating the washed fraction sample of step (2); and (4) drying the concentrate of step (3).

In another embodiment of the present invention, the porous support is at least one selected from the group consisting of zeolite, alumina, active carbon, and silica.

In another embodiment of the present invention, the silica may be at least one selected from the group consisting of MSU (Michigan state University) series, SBA (Santa Barbara) series, MCM (Mobil Composition of Matter, Mobil Co.) series, and KIT (Korea Advanced Institute of Science and Technology, KAIST) series.

In another embodiment of the present invention, the amino acid may be at least one selected from the group consisting of: valine (Val), leucine (Leu), isoleucine (Ile), methionine (Met), phenylalanine (Phe), asparagine (Asn), glutamic acid (Glu), aspartic acid (Asp), glycine (Gly), alanine (Ala), serine (Ser), threonine (Thr), cysteine (Cys), proline (Pro), glutamine (Glu), histidine (His), lysine (Lys), arginine (Arg), tyrosine (Tyr), and tryptophan (Trp).

Another aspect of the present invention provides a method for manufacturing a carbon dioxide adsorbent with an amino acid-based amine group grafted thereto, comprising the steps of: (1) preparing an ionic liquid; (2) stirring the ionic liquid of step (1), together with a porous support; (3) filtering the resulting mixture of step (2) and extracting the filtrate to obtain an ionic liquid-loaded porous support; (4) subjecting the ionic liquid-loaded porous support of step (3) to ion exchange with a basic solution containing a hydroxyl group (—OH), followed by washing; and (5) stirring the ion-exchanged porous support, together with an amino acid, in distilled water to graft an amine functional group to the porous support.

In one exemplary embodiment of the present invention, the stirring of step (2) is carried out at 50 to 70° C. for 20 to 30 hrs.

In another exemplary embodiment of the present invention, the extraction of step (3) is carried out in a soxhlet extractor using dichloromethane as a solvent.

In another exemplary embodiment of the present invention, the basic solution containing a hydroxyl group (—OH) of step (4) is a sodium hydroxide (NaOH) solution, a potassium hydroxide (KOH) solution or an ammonium hydroxide (NH₄OH) solution.

In another exemplary embodiment of the present invention, the stirring of step (5) is carried out for 20 to 30 hrs.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a graph of nitrogen adsorption-desorption isotherms of carbon dioxide adsorbents with amine groups from amino acids (Lys, Gly, Pro, Ala) grafted thereto in accordance with the present invention (OMS: ordered mesoporous silica, IL: ionic liquid);

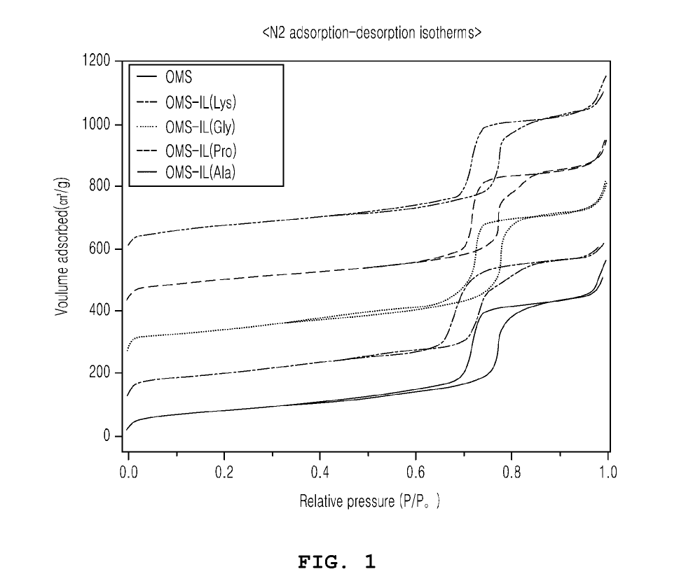

FIG. 2 is a graph of pore size distributions of carbon dioxide adsorbents with amine groups from amino acids (Lys, Gly, Pro, Ala) grafted thereto in accordance with the present invention;

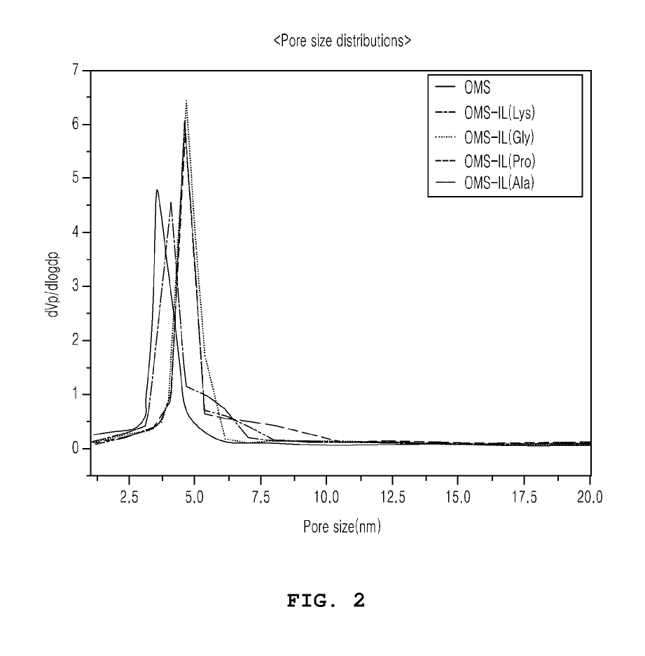

FIG. 3 is a graph of Fourier-transform infrared (FT-IR) spectra of carbon dioxide adsorbents with amine groups from amino acids (Gly, Lys) grafted thereto in accordance with the present invention, showing the fixation of the amine functional group from the amino acids (SBA-IL(Cl): before ion exchange of the ionic liquid loaded to SBA, SBA-IL(OH): after ion exchange of the ionic liquid loaded to SBA);

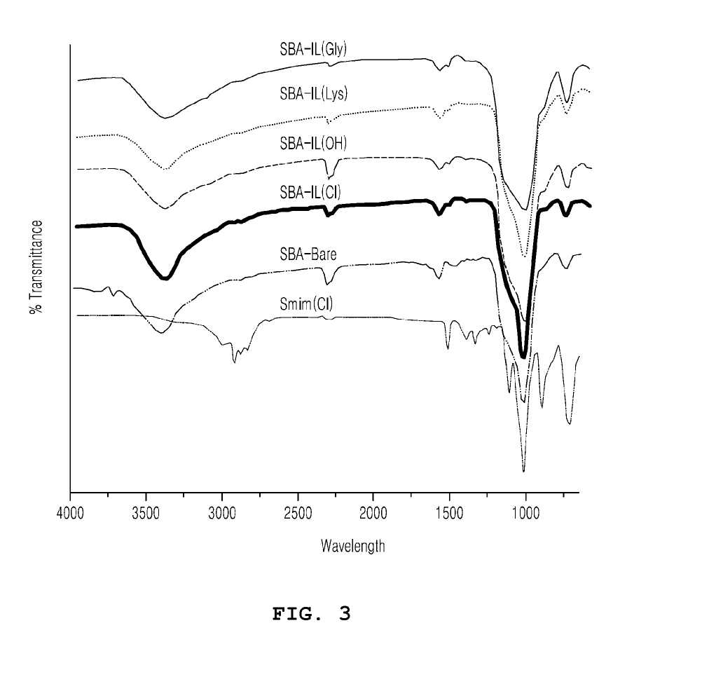

FIG. 4 is a graph showing amounts of ionic liquid loaded to carbon dioxide adsorbents with amine functional groups from amino acids (Lys, Gly, Pro, Ala) grafted thereto, as measured by thermal gravimetric analysis (TGA);

FIG. 5 is a graph showing amounts of ionic liquid loaded to carbon dioxide adsorbents respectively prepared by single graft, double grafting, and single graft with increased timing methods (SG-Cl: single graft, DG-Cl: double grafting, IT-Cl: single graft with twice increased timing);

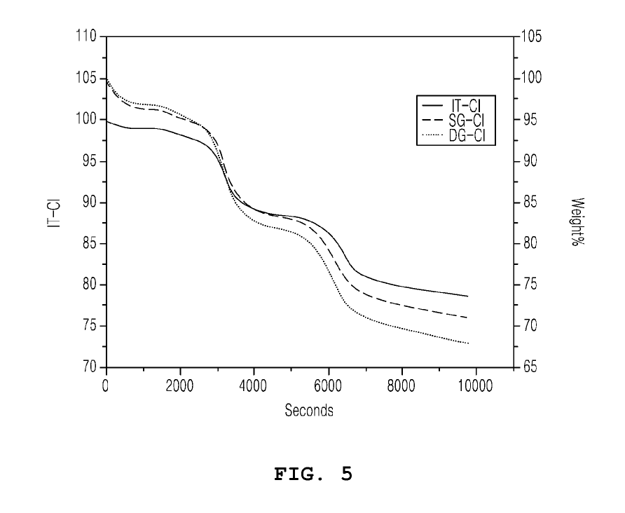

FIG. 6 is a graph of the carbon dioxide adsorption performance of a carbon dioxide adsorbent having an amino acid (Lys)-based amine group grafted thereto, as measured by thermal gravimetry analysis (TGA);

FIG. 7 is a graph showing the reusability of carbon dioxide adsorbents having an amino acid (Lys)-based amine group grafted thereto, as measured by a cycle test using thermal gravimeter; and

FIG. 8 is a graph of the carbon dioxide adsorption performance of carbon dioxide adsorbents with amine groups from amino acids (Lys, Gly, Pro, Ala) grafted thereto, as measured by thermal gravimetry analysis (TGA).

### DESCRIPTION OF THE PREFERRED EMBODIMENTS

Below, a detailed description will be given of the present invention.

In accordance with an aspect thereof, the present invention addresses a carbon dioxide adsorbent comprising an ionic liquid-loaded porous support with an amino acid-based amine functional group grafted thereto.

An ionic liquid is a salt, composed of a cation and an anion, which remains in a liquid state at around room temperature. Generally, ionic liquids are more flame retardant, less explosive, and stable over a wider range of temperatures than are molecular organic solvents. In addition, ionic liquids are characterized by high solubility for various materials. In the procedure of carbon dioxide adsorption, and regeneration, thus, ionic liquids may be relatively free from various problems including contamination with absorbent liquid, a reduction in absorbent liquid quantity, air pollution according to the atmospheric exposure of absorbent liquid and additional energy use for recovering pollutants, and those caused by the use of water as an ingredient of absorbent liquid. In consideration of these factors, hence, an ionic liquid is a useful material for sequestering carbon dioxide.

Sources for cations of ionic liquids are usually those having organic skeletons such as imidazolium, pyridinium, quaternary ammonium, phosphonium, etc. Representative among cations of ionic liquids are halogen ions, [BF₄]⁻, [PF₆]⁻, and fluorinated amides (e.g., (CF₃SO₂)₂N⁻). Ionic liquids of various structures have been developed from these sources and others. In the present invention, an ionic liquid was synthesized as follows, and called “[Smim]Cl” (1-(tri-ethoxy-silyl-propyl)-3-methyl-imidazolium chloride). The ionic liquid of the present invention is prepared by: (1) heating 1-methylimidazole in mixture with (3-chloropropyl)trimethoxysilane while stirring in a nitrogen atmosphere; (2) cooling the reaction mixture of step (1) to room temperature, followed by washing with diethyl ether; (3) concentrating the washed fraction sample of step (2); and (4) drying the concentrate of step (3).

In one exemplary embodiment of the present invention, the porous support is at least one selected from zeolite, alumina, active carbon, and silica. The silica may be selected from the group consisting of, but not limited to, MSU(Michigan state University) series, SBA (Santa Barbara) series, MCM (Mobil Composition of Matter, Mobil Co.) series, and KIT(Korea Advanced Institute of Science and Technology, KAIST) series.

In another embodiment of the present invention, the amino acid from which the amine functional group is sourced may be at least one selected from the group consisting of: valine (Val), leucine (Leu), isoleucine (Ile), methionine (Met), phenylalanine (Phe), asparagine (Asn), glutamic acid (Glu), aspartic acid (Asp), glycine (Gly), alanine (Ala), serine (Ser), threonine (Thr), cysteine (Cys), proline (Pro), glutamine (Glu), histidine (His), lysine (Lys), arginine (Arg), tyrosine (Tyr), and tryptophan (Trp).

Contemplated in accordance with another aspect of the present invention, is a method for manufacturing a carbon dioxide adsorbent with an amino acid-based amine group grafted thereto; comprising the steps of: (1) preparing an ionic liquid; (2) stirring the ionic liquid of step (1), together with a porous support; (3) filtering the resulting mixture of step (2) and extracting the filtrate to obtain an ionic liquid-loaded porous support; (4) subjecting the ionic liquid-loaded porous support of step (3) to ion exchange with a basic solution containing a hydroxyl group (—OH), followed by washing; and (5) stirring the ion-exchanged porous support, together with an amino acid, in distilled water to graft an amine functional group to the porous support.

In one exemplary embodiment of the present invention, the stirring of step (2) is carried out at 50 to 70° C. for 20 to 30 hrs.

In another exemplary embodiment of the present invention, the extraction of step (3) is carried out in a soxhlet extractor using dichloromethane as a solvent.

In another exemplary embodiment of the present invention, the basic solution containing a hydroxyl group (—OH) of step (4) is a sodium hydroxide (NaOH) solution, a potassium hydroxide (KOH) solution or an ammonium hydroxide (NH₄OH) solution.

In another exemplary embodiment of the present invention, the stirring of step (5) is carried out for 20 to 30 hrs.

A better understanding of the present invention may be obtained through the following examples which are set forth to illustrate, but are not to be construed as limiting the present invention.

### EXAMPLE 1

### Preparation of Ionic Liquid

To 8.21 g (0.1 mol) of 1-methylimidazole was added 19.87 g (0.1 mol) of (3-chloropropyl)trimethoxysilane, and the mixture was heated at 95° C. for 26 hrs while stirring in a nitrogen atmosphere. The resulting reaction mixture was cooled to room temperature, and washed three times with 20 ml of diethyl ether. In this regard, the diethyl ether was fed through a Thimble filter (ADVENTEC 88R).

The extracted fraction was concentrated using a rotary evaporator, after which the concentrate was dried at room temperature in a vacuum to give an ionic liquid, designated “[Smim]Cl” (1-(tri-ethoxy-silyl-propyl)-3-methyl-imidazolium chloride).

### EXAMPLE 2

### Preparation of Carbon Dioxide Adsorbent Having Ionic Liquid-Loaded Porous Support with Amino Acid-Based Amine Functional Group Introduced thereinto

In the present invention, the porous silica SBA-15 was used as a support to which an ionic liquid would be loaded. SBA-15 is a silica particle with a large surface area in which both mesopores and micropores are formed in a three-dimensional structure. Also, the silica has a thick micropore wall, and exhibits high hydrothermal stability. Hence, SBA-15 is very useful as an adsorbent.

In order to prepare the carbon dioxide absorbent of the present invention, first, 2.8 g of the ionic liquid [Smim]Cl precursor obtained in Example 1 was dissolved in 150 ml of chloroform, and the resulting solution was added with 2 g of SBA-15 and stirred at 61° C. for 24 hrs.

The resulting mixture was filtered through a paper filter using chloroform and ether. The filtrate was refluxed for 20 hrs in a soxhlet extractor, with dichloromethane serving as a solvent, to extract ionic liquid-loaded SBA-15. The SBA-15 extract was stirred for 4 hrs in a 2.5M NaOH solution to exchange Cl⁻ ions of the ionic liquid loaded to SBA-15 with OH⁻ ions. Subsequently, the resulting mixture was washed three time with distilled water to yield [Smim]⁺OH⁻SBA.

For a neutralization reaction, 0.6 g of [Smim]⁺OH⁻SBA was stirred together with 1 g of amino acids (lysine, glycine, proline, alanine, etc.) in 50 ml of distilled water for 24 hrs, followed by washing with ethanol and distilled water to yield a carbon dioxide adsorbent comprising an ionic liquid-loaded porous support with an amino acid-based amine functional group introduced thereinto.

### TEST EXAMPLE 1

### Elemental Analysis

The carbon dioxide absorbents manufactured according to the present invention were analyzed for elemental composition using an elemental (C, N, S) analyzer (Model: Flash EA 1112) in the Stable Analysis Lab of the National Instrumentation Center for Environmental Management (NICEM). The results are summarized in Table 1, below.

TABLE 1
CHN-Elemental analysis of OMS-IL (AA) samples

| | N | C | H |
|---|---|---|---|
| OMS-IL (AA) | (wt %) | (wt %) | (wt %) |
| OMS-IL (Pro) | 2.6351 | 5.9335 | 1.3897 |
| OMS-IL (Lys) | 3.1822 | 8.6553 | 1.8617 |
| | N | C | H |
| OMS-IL (AA) | (mmoles/g) | (mmoles/g) | (mmoles/g) |
| OMS-IL (Pro) | 1.8 | 0.6 | 0.18 |
| OMS-IL (Lys) | 2.27 | 1.13 | 0.61 |

*OMS: ordered mesoporous silica;
IL: ionic liquid;
AA: amino acid

### TEST EXAMPLE 2

### Comparison of Ionic Liquid Loads

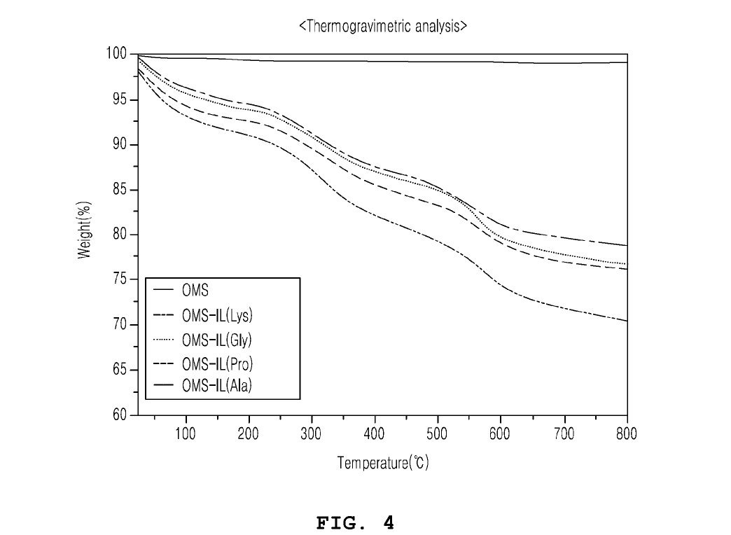

The carbon dioxide adsorbents with an amine group of amino acids (Lys, Gly, Pro, Ala) introduced thereinto, manufactured according to the present invention, were measured for the loaded amount of the ionic liquid by thermogravimetry (FIG. 4), and the measurements were calculated into quantitative data using ASCII codes. The results are given in Table 2, below.

TABLE 2

| OMS-IL (AA) | Amount loaded (wt. %) |
|---|---|
| OMS-IL (Lys) | 21.43 |
| OMS-IL (Gly) | 23.03 |
| OMS-IL (Pro) | 23.12 |
| OMS-IL (Ala) | 29.60 |

*OMS: ordered mesoporous silica;
IL: ionic liquid;
AA: amino acid
*Temp. condition 25~800° C.

### TEST EXAMPLE 3

### Comparison of Ionic Liquid Loads Among Loading Procedures of Single Graft, Double Graft, and Single Graft with Increased Timing

Examination was made of a condition under which optical efficiency for the amount of ionic liquid loaded to the porous support (SBA-15). To this end, samples were obtained under the following three conditions of: 1) single graft: a sample was obtained by conducting a part of overall procedure of Examples 1 and 2, that is, a procedure of from the ionic liquid preparation to the extraction of an ionic liquid-loaded SBA-15 by stirring the ionic liquid [Smim]Cl together with SBA-16 in an soxhlet extractor; 2) double grafting: repeating the single graft procedure twice; and 3) single graft with increased timing: a sample was obtained in the same manner as in the single graft procedure with the exception that the stirring was conducted for 48 hrs, twice longer than in the single graft. The samples were measured for the amounts of ionic liquid loaded into SBA-15 by thermogravimetry. The results are summarized in Table 3, below. As can be seen, the greatest loaded amount of ionic liquid was obtained by the double grafting procedure.

TABLE 3

| | Ionic liquid loaded |
|---|---|
| Approach | (in weight %) |
| Single graft | 24.9 |
| Single graft with increased timing | 20.0 |
| Double grafting | 28.5 |

### TEST EXAMPLE 4

### Analysis for Adsorption Performance of

Carbon Dioxide Adsorbent with Amino Acid(Lys)-Based Amine Group Grafted thereto

Of the carbon dioxide absorbents comprising the SBA-15 with amino acid-based amine group introduced thereinto, 20 mg of the absorbent employing lysine (Lys) was used. The Lys-introduced absorbent was loaded to the pan of a thermogravimeter (Scinco, TGA N-1000), and pretreated by heating to 100° C. (ascending rate 10° C./min), maintaining at this temperature for 60 min, and then cooling to room temperature (descending rate 30° C./min). Thereafter, adsorption was carried out for 60 min in a 100% CO₂ atmosphere. In cycle tests, desorption at 105° C. for 30 min was followed by resorption.

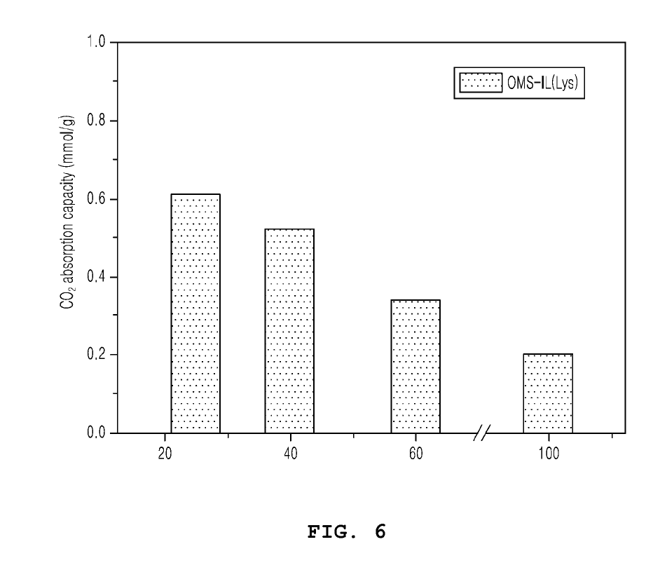

In FIG. 6 and Table 4, the adsorption capacity of the adsorbent according to temperature is given. As can be seen, the adsorption capacity increased with a decrease in temperature, but was maintained at an acceptable level even at temperatures as high as 100° C.

TABLE 4

| Absorption Temperature | Adsorption capacity (mmol/g) |
|---|---|
| 25 | 0.61 |
| 40 | 0.52 |
| 60 | 0.34 |
| 100 | 0.2 |

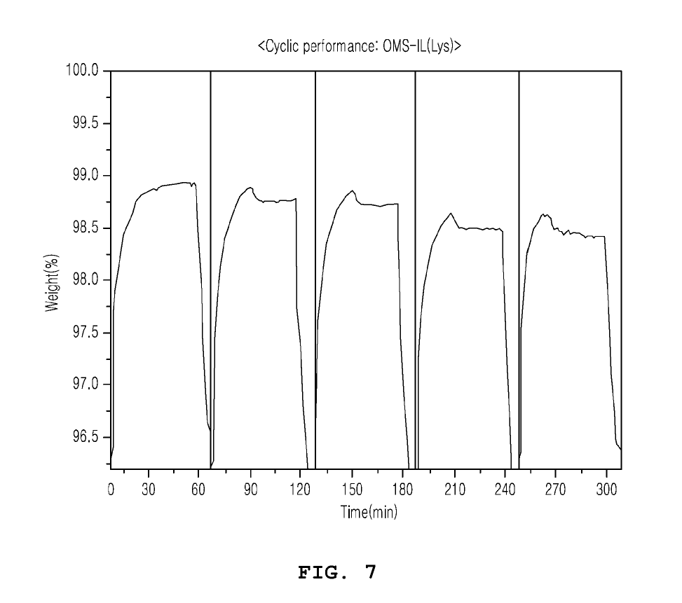

The cycle test results are given in FIG. 7 and Table 5. As understood from the data, high resorption levels of carbon dioxide were detected even after many adsorption cycles, demonstrating excellent reusability of the carbon dioxide adsorbent.

TABLE 5

| cycle | Adsorption capacity (%) |
|---|---|
| 1 | 2.7 |
| 2 | 2.67 |
| 3 | 2.62 |
| 4 | 2.3 |
| 5 | 2.3 |

### TEST EXAMPLE 5

### Comparison of Adsorption Performance Among Carbon Dioxide Adsorbents with Amino Acid(Lys, Gly, Pro, Ala)-Based Amine Groups Introduced thereinto

Each of the carbon dioxide adsorbents comprising an ionic liquid-loaded SBA-15 with an amine group from respective amino acids lysine (Lys), glycine (Gly), proline (Pro), and alanine (Ala) introduced thereinto was loaded in an amount of 20 mg to the pan of a thermogravimeter. For pretreatment, the absorbents were heated to 100° C. (ascending rate 10° C./min), maintained at this temperature for 60 min, and then cooled to room temperature (descending rate 30° C./min). Thereafter, adsorption was carried out for 60 min in a 100% CO₂ atmosphere.

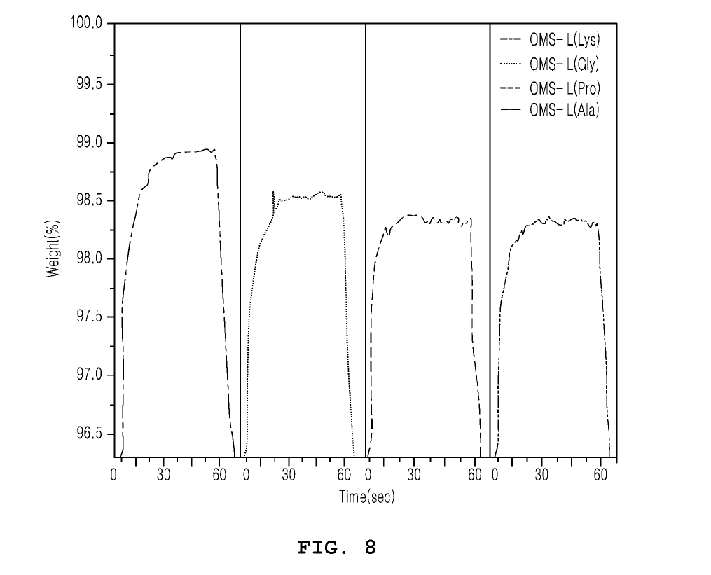

As can be seen in FIG. 8 and Table 6, the higher carbon dioxide adsorption performance was observed in the absorbent with a lysine-based amine group introduced thereto than in the other absorbents because lysine has more amino groups than do the others. Similar adsorption levels were detected among the others.

TABLE 6

| OMS-IL (AA) | Adsorption capacity (%) |
|---|---|
| OMS-IL (Lys) | 2.68 |
| OMS-IL (Gly) | 2.32 |
| OMS-IL (Pro) | 2.20 |
| OMS-IL (Ala) | 2.22 |

*OMS: Ordered mesoporous silica;
IL: ionic liquid;
AA: amino acid

As described hitherto, the present invention provides a carbon dioxide adsorbent, comprising an ionic liquid-loaded porous support with an amino acid-based amine functional group grafted thereto, and a method for manufacturing the same. Having excellent carbon dioxide adsorption performance, selectivity for carbon dioxide, thermal stability, and reusability, the carbon dioxide adsorbent of the present invention can be effectively applied to the prevention of environmental pollution produced by carbon dioxide release.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A carbon dioxide adsorbent, comprising an ionic liquid-loaded porous support with an amino acid-based amine functional group grafted thereto.

2. The carbon dioxide adsorbent of claim 1, wherein the ionic liquid is prepared by:
(1) heating 1-methylimidazole in mixture with (3-chloropropyl)trimethoxysilane while stirring in a nitrogen atmosphere;
(2) cooling the reaction mixture of step (1) to room temperature, followed by washing with diethyl ether;
(3) concentrating the washed fraction sample of step (2); and (4) drying the concentrate of step (3).

3. The carbon dioxide adsorbent of claim 1, wherein the porous support is at least one selected from the group consisting of zeolite, alumina, active carbon, and silica.

4. The carbon dioxide adsorbent of claim 3, wherein the silica is at least one selected from the group consisting of MSU(Michigan state University) series, SBA (Santa Barbara) series, MCM (Mobil Composition of Matter, Mobil Co.) series, and KIT(Korea Advanced Institute of Science and Technology, KAIST) series.

5. The carbon dioxide adsorbent of claim 1, wherein the amino acid is at least one selected from the group consisting of: valine (Val), leucine (Leu), isoleucine (Ile), methionine (Met), phenylalanine (Phe), asparagine (Asn), glutamic acid (Glu), aspartic acid (Asp), glycine (Gly), alanine (Ala), serine (Ser), threonine (Thr), cysteine (Cys), proline (Pro), glutamine (Glu), histidine (His), lysine (Lys), arginine (Arg), tyrosine (Tyr), and tryptophan (Trp).

6. A method for manufacturing a carbon dioxide adsorbent with an amino acid-based amine group grafted thereto, comprising the steps of:
(1) preparing an ionic liquid;
(2) stirring the ionic liquid of step (1), together with a porous support;
(3) filtering the resulting mixture of step (2) and extracting the filtrate to obtain an ionic liquid-loaded porous support;
(4) subjecting the ionic liquid-loaded porous support of step (3) to ion exchange with a basic solution containing a hydroxyl group (-OH), followed by washing; and
(5) stirring the ion-exchanged porous support, together with an amino acid, in distilled water to introduce an amine functional group into the porous support.

7. The method of claim 6, wherein the stirring of step (2) is carried out at 50 to 70° C. for 20 to 30 hrs.

8. The method of claim 6, wherein the extraction of step (3) is carried out in a soxhlet extractor using dichloromethane as a solvent.

9. The method of claim 6, wherein the basic solution containing a hydroxyl group (—OH) of step (4) is a sodium hydroxide (NaOH) solution, a potassium hydroxide (KOH) solution or an ammonium hydroxide (NH₄OH) solution.

10. The method of claim 6, wherein the stirring of step (5) is carried out for 20 to 30 hrs.
